(19) United States
(12) Patent Application Publication
(10) Pub. No.: US 2016/0170235 A1
(43) Pub. Date: Jun. 16, 2016

(54) FASHION-EYEZED

(71) Applicant: Rosemarie Maalouf, Bayville, NJ (US)

(72) Inventor: Rosemarie Maalouf, Bayville, NJ (US)

(21) Appl. No.: 14/970,686

(22) Filed: Dec. 16, 2015

Related U.S. Application Data
(60) Provisional application No. 62/092,594, filed on Dec. 16, 2014.

(51) Int. Cl. G02C 11/02; G02C 13/00; G02C 3/00

(52) U.S. Cl. CPC G02C 11/02; G02C 3/006; G02C 13/006; G02C 2200/10; G02C 2200/16

(57) ABSTRACT

An eyeglasses covering has a tubular member that is attached to a pair of eyeglasses where the tubular member is capable of covering or uncovering one or both of the lenses of the eyeglasses. A length of wire or other flexible element is contained partially along the length of the tubular member. This allows the eyeglasses covering to be used as an accessory when the lenses are covered and not in use. For example, the eyeglasses covering may double as a headband, necklace, or bracelet depending on the size and type of eyeglasses being used or being covered. The eyeglasses covering may be further adorned to create a more fashionable impression.

### CLAIM OF PRIORITY

This application claims priority to U.S. Application 62/092,594 filed on Dec. 16, 2014, the contents of which is herein incorporated by reference in its entirety.

### FIELD OF THE EMBODIMENTS

The field of the invention and its embodiments relate to eyeglasses and coverings for eyeglasses. In particular, the present invention provides for an attachment to a pair of eyeglasses that can be used as a fashion accessory, such as a headband, when the pair of eyeglasses are not in use thereby masking the presence of the pair of eyeglasses.

### BACKGROUND OF THE EMBODIMENTS

Eyewear, such as protective eyewear, sunglasses, prescription eyewear, and the like, are generally fragile and must require protection from bending, breaking, or scratching. As such, there are a number of hard and soft cases on the market to help provide this protection. The level of protection required can depend on the type of eyewear and the individual who wears the eyeglasses. This means that the wearer must have with them not only their eyeglasses but also their eyeglasses case at all times in order to securely stow their eyewear.

There are some eyewear cases or retainers that adhere to or are combined with the particular eyeglasses or eyewear. These cases couple to or integrate with the eyeglasses in some fashion to form a single unit. While such cases solve the multiple components issue many people experience, it gives rise to a number of other issues. Often, these combinations are unsightly and are typically visible on the wearer even while the eyewear is in use. Further, such cases or protectors can be bulky and cause discomfort while wearing the eyewear.

There is a need for a discrete eyeglasses cover and protection device. Preferably, the cover is lightweight and can be coupled to the eyewear without interfering with the user's daily activities. The present invention and its embodiments meets and exceeds these objectives.

### REVIEW OF RELATED TECHNOLOGY

U.S. Pat. No. 7,021,759 pertains to a protective cover for eyeglasses comprising a pair of complementary tubular members that are fitted over the temples of a pair of glasses, each tubular member having sufficient material or elasticity to stretch to completely cover the lenses of the eyeglasses and a means to fit snugly around the temples. A fixed retaining member is attached to one end of the tubular member and a one or more strips are attached about the opposite end of the tubular member, which end is intended to be stretched over the lenses. A sliding retaining member is also provided on the tubular member and is retained thereon by means of the fixed retaining member and the strips. In operation, the tubular member is retained on the temples by twisting the tubular member about the temple, using the fixed retaining member at one end and the combination of the strips and the sliding retaining member at the other end to frictionally engage the temple and prevent the tubular member from unravelling.

U.S. Pat. No. 6,478,145 pertains to a double rolled stretch fabric protective member detachably attached to a pair of connection members at each end to form an eyeglasses retainer and case combination with detachable straps. The connection members comprise tubular straps which may receive the stems of eyeglasses therein and held in place on the stems by elastic bands within the ends of the straps. The assembly is then worn around the head or neck as a retainer preventing the eyeglasses from sliding forward or falling off in sports and such. When the eyeglasses are not worn they can be folded and placed within the cavity formed by unrolling the double roll of the case.

U.S. Pat. No. 5,735,393 pertains to an eyeglass retainer/cover that is an integral combination eyeglass pouch and a neck strap fabricated from a single strip of flexible and stretchable fabric. The invention can be used to either retain eyeglasses on the neck strap or the integral pocket be stretched over folded eyeglasses to act as a cover for protection, storage, and cleaning when not being utilized as a neck strap. The eyeglass retainer/cover is easily constructed and has a stylish appearance because the integral eyeglass pocket folds into itself when not in use.

Various devices are known in the art. However, their structure and means of operation are substantially different from the present disclosure. The other inventions fail to solve all the problems taught by the present disclosure. The present invention and its embodiments teach a cover for a pair of eyeglasses that completely envelops the eyeglasses when not in use. Further, the eyeglasses cover has flexible and stabilizing elements that allow the eyeglasses cover/eyeglasses combination to be worn as a necklace, headband, etc. when the eyeglasses are not being used. At least one embodiment of this invention is presented in the drawings below and will be described in more detail herein.

### SUMMARY OF THE EMBODIMENTS

An eyeglasses covering is described and taught that allows a pair of eyeglasses, when not in use, to be worn as a fashion accessory, the eyeglasses covering having a tubular length of material having a first end and a second end, wherein the first end has a first opening and the second end has a second opening, wherein the first opening and the second opening have an elastic material adhered thereto; a length of flexible material extending partially through the tubular length of material; a fastening mechanism for coupling the tubular length of material to the pair of eyeglasses; and wherein a first temple of the pair of eyeglasses is inserted in the first opening and a second temple of the pair of eyeglasses is inserted in the second opening.

In another embodiment of the present invention there is an eyeglasses covering that allows a pair of eyeglasses, when not in use, to be worn as a fashion accessory, the eyeglasses covering having a tubular length of material with a first end and a second end, wherein the first end has a first opening and the second end has a second opening, wherein the first opening and the second opening have an elastic material adhered thereto; a length of flexible wire extending partially through the tubular length of material; at least two fastening mechanisms for coupling the tubular length of material to the pair of eyeglasses; at least one stabilizing element applied to a surface of the tubular length of material; and wherein a first temple of the pair of eyeglasses is inserted in the first opening and secured with one of the at least two fastening mechanisms and a second temple of the pair of eyeglasses is inserted in the second opening and secured with the other of the at least two fastening mechanisms.

In yet another embodiment of the present invention there is an eyeglasses covering that allows a pair of eyeglasses, when not in use, to be worn as a fashion accessory, the eyeglasses covering having a unitary length of material having a first end and a second end with an stretchable first opening at the first end and a stretchable second opening at the second end, wherein the first end is capable of covering at least a first temple, a first lens, and at least a portion of a nose bridge of the pair of eyeglasses when the pair of eyeglasses are not in use, wherein the second end is capable of covering at least a second temple, a second lens, and at least a portion of the nose bridge of the pair of eyeglasses when the pair of eyeglasses are not in use, wherein the first end and the second end are capable of being retracted to at least partially expose the first lens and/or second lens when the pair of eyeglasses are in use; and a length of flexible material extending partially or wholly through the unitary length of material, wherein the length of flexible material allows the unitary length of material to be shaped and substantially retain that shape.

Generally, the eyeglasses covering has a tubular member that is attached to a pair of eyeglasses where the tubular member is capable of covering or uncovering one or both of the lenses of the eyeglasses. The tubular member is attached via a fastening mechanism which may be a tie, loop, ring, snap, clasp, Velcro®, teeth/groove, or the like or some combination thereof. The tubular member may be a fabric or textile of both natural and/or synthetic origins.

A length of wire or other flexible or semi-rigid element is contained partially along the length of the tubular member. This allows the eyeglasses covering to be used as an accessory when the lenses are covered and not in use. For example, the eyeglasses covering, may double as a headband, necklace, or bracelet depending on the size and type of eyeglasses being used or being covered. The eyeglasses covering may be further adorned to create a more fashionable impression.

To use the eyeglasses covering, the tubular member is simply attached to the eyeglasses preferably near the temple region. The connection point may be moved along most any point of the frame of the eyeglasses. The ends of the tubular member can then be positioned in a “use” or “non-use” configuration. In a “use” configuration the ends of the tubular member are positioned to at least partially expose at least one lens of the eyeglasses. In a “non-use” configuration the ends of the tubular member meet at the bridge of the eyeglasses thereby covering the lenses and eyeglasses collectively. When in a non-use configuration the eyeglasses may be adequately disguised and worn as an accessory such as a headband, necklace, bracelet, or the like.

In general, the present invention succeeds in conferring the following, and others not mentioned, benefits and objectives.

It is an object of the present invention to provide an eyeglasses covering that is lightweight.

It is an object of the present invention to provide an eyeglasses covering that provides an element of protection to the underlying eyeglasses.

It is an object of the present invention to provide an eyeglasses covering that conforms to the eyeglasses.

It is another object of the present invention to provide an eyeglasses covering that is detachable from the eyeglasses.

It is another object of the present invention to provide an eyeglasses covering that can be worn as an accessory when the eyeglasses are not in use.

It is another object of the present invention to provide an eyeglasses covering that can be shaped to conform to a certain shape or body part.

It is still another object of the present invention to provide an eyeglasses covering that fully covers the frame and lenses of the eyeglasses.

It is still another object of the present invention to provide an eyeglasses covering that can be matched to other articles of clothing to create a clothing ensemble.

It is still another object of the present invention to provide an eyeglasses covering that can be used in conjunction with eyeglasses of varying shapes and/or styles.

### BRIEF DESCRIPTION OF THE DRAWINGS

FIG. 1 is a perspective view of an embodiment of the present invention showing the eyeglasses covering being coupled to a pair of eyeglasses and exposing the lenses and part of the temples.

FIG. 2 is a perspective view of an embodiment of the present invention showing the eyeglasses covering being coupled to a pair of eyeglasses and covering the lenses, temples, and nose bridge.

FIG. 3 is a perspective view of an embodiment of the present invention showing the eyeglasses covering being coupled to a pair of eyeglasses and covering the eyeglasses with the covered structures being shown underneath.

FIG. 4A illustrates an example of a pair of eyeglasses being worn with an embodiment of the present invention coupled thereto.

FIG. 4B illustrates an example of a pair of eyeglasses being worn as an accessory with an embodiment of the present invention coupled thereto.

FIG. 4C illustrates another example of a pair of eyeglasses being worn as another accessory with an embodiment of the present invention coupled thereto.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

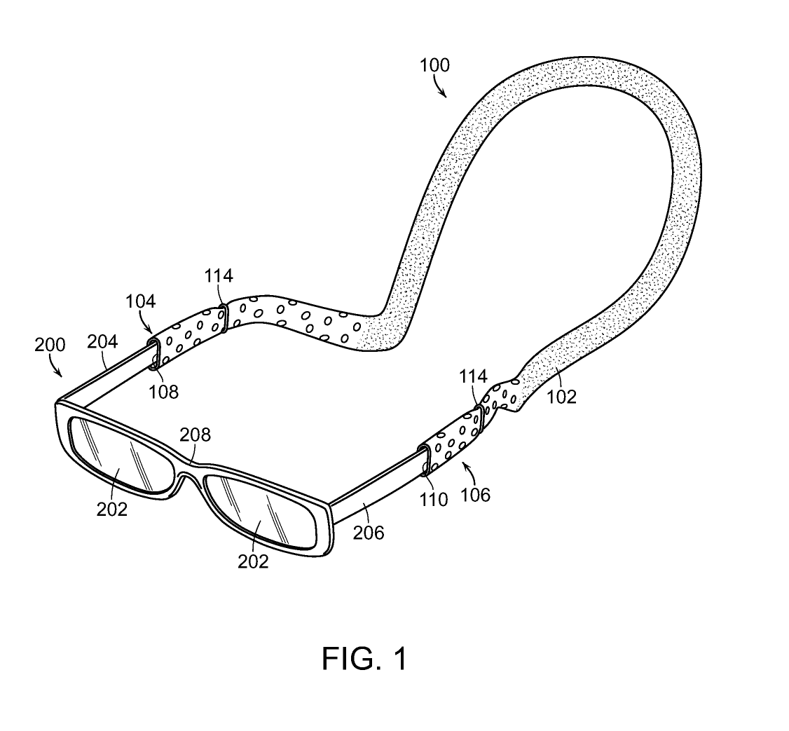

Referring now to FIG. 1, there is a pair of eyeglasses 200 and an eyeglasses covering 100 coupled thereto. The pair of eyeglasses 200 and the eyeglasses covering 100 are shown coupled but with the lenses 202 remaining uncovered. The eyeglasses covering 100 is formed from a length of tubular material (tubular member) 102 having a first end 104 and a second end 106. Each of the first end 104 and the second end 106 has a first opening 108 and a second opening 110 respectively.

Preferably, a first temple 204 of a pair of eyeglasses 200 is inserted into the first opening 108 and a second temple 206 into the second opening 110. Thereafter some length of the tubular member 102 covers each of the respective temples while providing enough material to allow the openings to completely cover the lenses 202 and nose bridge 208. After such a length has been determined, fastening mechanisms 114 can be used to secure the position of the length of tubular material 102.

The length of tubular material or tubular member 102 may vary in length and may be between about 39 cm (12 inch) to about 122 cm (48 inch). The length of tubular material may comprise a number of materials including but not limited to woven or unwoven fabric, cloth, terrycloth, woven or woven fibers of wool, flax, cotton, and/or yarn, and synthetic textile including but not limited to nylon, polyester, and/or acrylic, co-polymers (e.g. Spandex®) or any combinations thereof. In some instances, the tubular material may 102 be transparent or translucent.

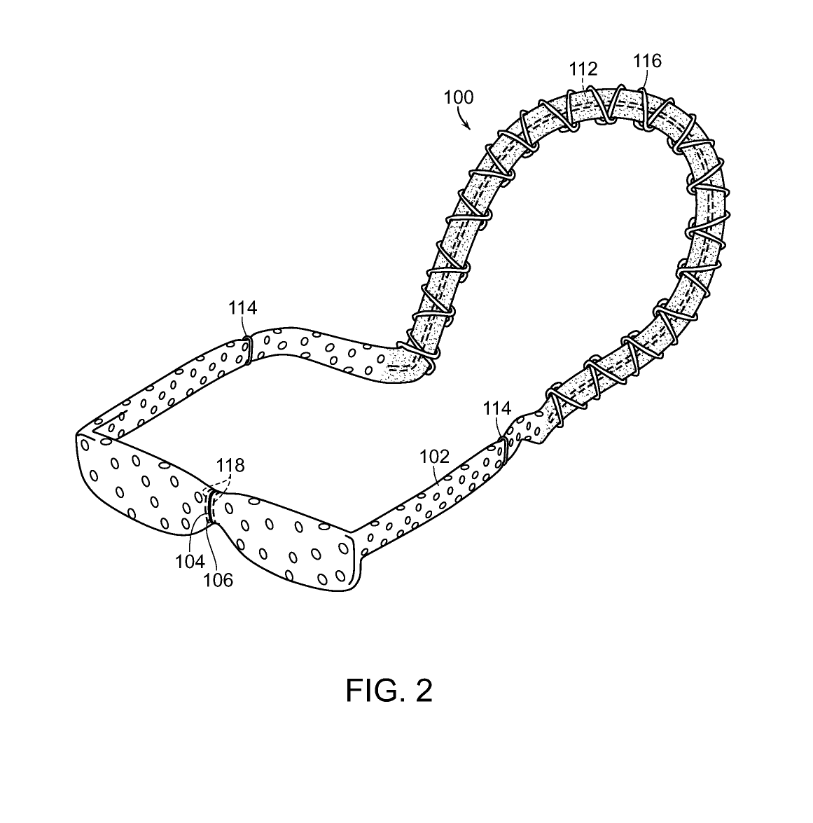

It is desirable that the tubular member 102 provides enough compression to fit around the pair of eyeglasses 200 without becoming caught or causing difficulty in adjusting the position of the tubular member 102. Ideally, the position of the tubular member 102 is primarily secured using the fastening mechanisms 114 and the elastic opening 118 (see FIG. 2).

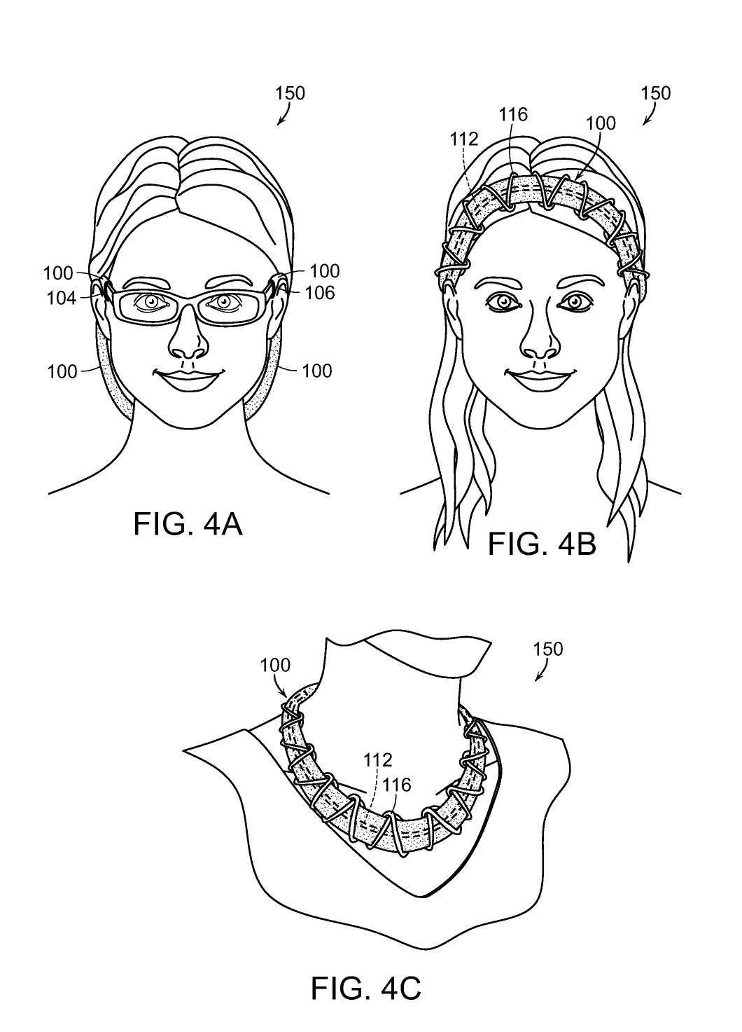

Along the length of the tubular material not overlaid with the temples, there may be a stabilizing element 116, as shown in FIG. 2. Preferably, this is used in conjunction with the flexible material 112 (see FIG. 2) to provide some element of rigidity to the eye glasses covering 100 enabling the covering to be used in any number of manners and some of which are shown in at least FIGS. 4A-C. This stabilizing element 116 may be of varying colors and materials and may be selected for matching a color scheme of one's clothing or of the tubular member 102 itself.

The fastening mechanisms 114 may be a length of material tied or otherwise compressed or cinched around the temple portions of the pair of eyeglasses 200. In some embodiments elastic bands, O-rings, rubber bands, snaps, clasps, Velcro®, teeth/groove, and the like or a combination thereof may be used. Regardless of the form of the fastening mechanism 114 the nature of the mechanism should enable the fastening mechanism 114 to adequately secure the position of the tubular member 102 along the temple whilst readily being removable and/or repositionable.

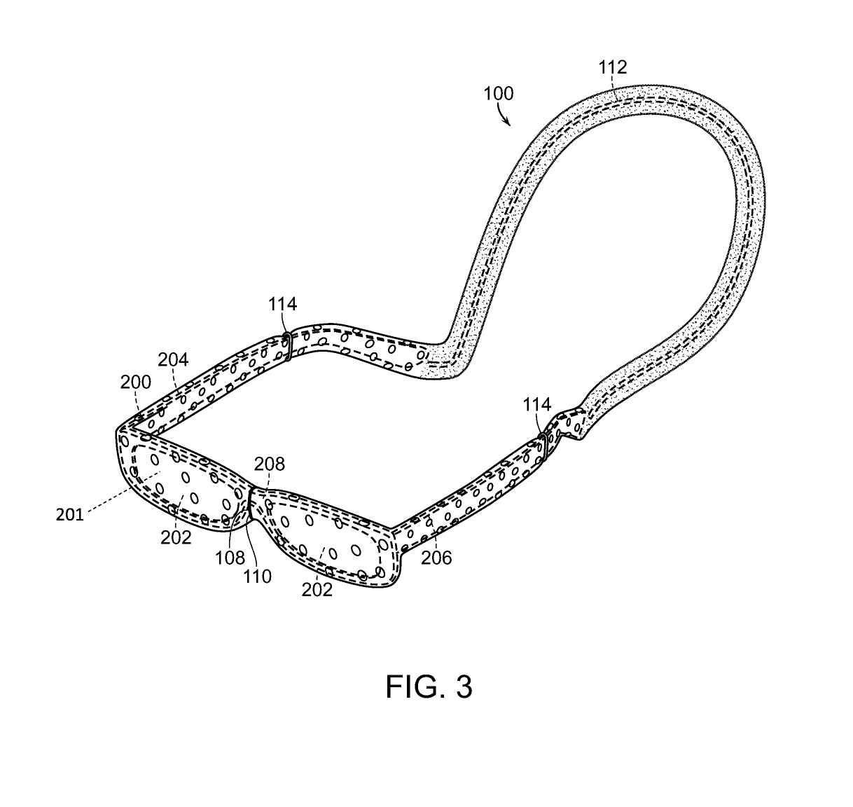

Referring now to FIGS. 2 and 3, the eyeglasses covering 100 is shown fully covering a pair of eyeglasses 200. The eyeglasses covering 100 as previously described is coupled to the temples via the fastening mechanism 114 with enough length of tubular material 102 to enable the covering of the lenses 202, as shown in FIG. 2, and nose bridge without having to adjust the fastening mechanisms 114. In FIG. 3, the underlying relationship between the eyeglasses 200 and the eyeglasses covering 100 is shown.

In order to place the eyeglasses covering 100 fully over the pair of eyeglasses 200 (see FIG. 2) in a “non-use” position, each end of the tubular member 102 is extended over the temples, lenses, and nose bridge. The first end 104 and the second end 106, as shown in FIG. 2, each have elastic 118 surrounding the respective openings. This enables the ends 104, 106 to stretch to cover the lenses 200 and then return to snugly hug the nose bridge 208. As shown in FIG. 3, the first opening 108 and the second opening 110 meet in the middle of the nose bridge 208. In some instances, there may be overlap between the two openings to prevent the eyeglasses 200 from being exposed. Thus, it is clearly shown and intended that the eyeglasses covering 100 will fully cover the lenses 202 nose bridge 208, first temple 204, and second temple 206.

At some point along the length of tubular material 102, the pair of eyeglasses 200 will cease to exist and there will be an excess of material. The amount of excess material may vary and can be tailored to a particular length depending on a certain usage. Preferably, once the temple (or other comparable portion) of the eyeglasses 200 ends, a length of flexible material 112 begins. The flexible material 112 while called “flexible” may be flexible or semi-rigid depending on the application. Generally, it is desired the flexible material 112 is capable of being bent or shaped and substantially retaining that shape until otherwise so desired. In some embodiments, the flexible material 112 is a length of metallic wire.

The flexible material 112 should be arranged to be coupled to either the temples or the eyeglasses covering 100 itself. A pocket may reside in the interior of the eyeglasses covering 100 that enables the ends of the flexible material 112 to be retained. Further, the stabilizing element 116 may provide additional rigidity or positioning of the flexible element 112 by providing a number of interlocking rings around a portion of the tubular member 102.

For example, the tubular member 102 may pass through a portion of the stabilizing element 116 with the flexible material 112 also passing therethrough. The stabilizing element 116 can then be essentially interwoven with the flexible element 112 thereby securing the position of the flexible element 112 and providing additional rigidity to the structure as a whole. The stabilizing element 116 is preferably arranged to allow the portion of the tubular member 102 containing the flexible element 112 to be positioned in virtually any shape desired by a user. This may be achieved by utilizing a number of interlocking rings, as noted above, or various other interrelated element(s) that allow for bending, twisting, kinking, and the like of the tubular member 102. This is just one iteration of such a stabilizing element 116/flexible element 112 relationship and numerous other configurations are possible.

Further, in FIG. 3, it is contemplated that the eyeglasses covering 100 may have a lens cleaning material 201 contained within an inner surface of the eyeglasses covering 100 in an area intended to cover the lenses 202. In other embodiments, the lens cleaning material 201 covers the entire inner surface of the eyeglasses covering 100. In yet other embodiments, the lens cleaning material 201 may be removable and/or replaceable. Thus, the lens cleaning material 201 may be coupled to the eyeglasses covering 100 via conventional mechanisms such as hook and loop fasteners. The material comprising the lens cleaning material 201 may be a microfiber material and may have a “ribbon” like structure to help remove dirt, dust, etc. from the lens surface.

Referring to FIGS. 4A-C, there are multiple potential uses of the present invention and its embodiments shown. As shown in FIG. 4A, the eyeglasses 200 (see FIG. 1) are worn by a user 150 with the eyeglasses covering 100 attached thereto. The eyeglasses 200 are generally worn as is convention with the temples positioned over the ears. The eyeglasses covering 100 passes behind the user's head and limits discomfort or distraction while wearing.

FIG. 4B demonstrates one method of wearing the eyeglasses 200 (see FIG. 1) and eyeglasses covering 100 combination when the eyeglasses covering 100 is preferably configured as shown in FIG. 2. The flexible element 112 can be arced to form a generally semi-circular portion of the eyeglasses covering 100. Thus, as shown, the user 150 is wearing the eyeglasses covering 100 as a headband. The eyeglasses 200 themselves are positioned to the rear obscuring them from view preferably under the hair of the wearer. The stabilizing element 116 not only is functional in providing additional support, but detracts from the “flat” appearance of the eyeglasses covering 100. This enables one to effectively camouflage their eyeglasses without the need for a case, pocket, or the like. Additionally, the eyeglasses covering 100 provide an element of protection while doubling as a fashion accessory.

In FIG. 4C, there is an alternate position in which the present invention may be worn. As shown, the eyeglasses covering 100 with the eyeglasses positioned underneath is worn as a necklace. Again, the flexible element 112 faces forward along with the stabilizing element 116 creating the illusion of a piece of jewelry or other similarly situated item. The user 150 can further shape the flexible element 112 to match their particular style. For example, instead of a “smooth” arc the flexible element 112 may be shaped to form a wave pattern or a zig-zag pattern.

There are a number of configurations in which the present invention and its embodiments may be worn and are not limited to those explicitly described above. It is clear that the present invention may also function as a bracelet or other forms of personal adornment. Additionally, the present invention may be used to adorn other items such as purses, handbags, and the like.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An eyeglasses covering that allows a pair of eyeglasses, when not in use, to be worn as a fashion accessory, the eyeglasses covering comprising:
a tubular length of material having a first end and a second end,
wherein the first end has a first opening and the second end has a second opening,
wherein the first opening and the second opening have an elastic material adhered thereto;
a length of flexible material extending partially through the tubular length of material;
a fastening mechanism for coupling the tubular length of material to the pair of eyeglasses; and
wherein a first temple of the pair of eyeglasses is inserted in the first opening and a second temple of the pair of eyeglasses is inserted in the second opening.

2. The eyeglasses covering of claim 1 further comprising:
at least one stabilizing element applied to a surface of the tubular length of material.

3. The eyeglasses covering of claim 1 wherein the tubular length of material comprises at one or more natural or synthetic materials.

4. The eyeglasses covering of claim 1 wherein the length of flexible material is a wire.

5. The eyeglasses covering of claim 4 wherein the wire is coupled to a surface of the tubular length of material.

6. The eyeglasses covering of claim 4 wherein the wire has a flexibility and/or resiliency that permits the wire to be manipulated and substantially retain its shape.

7. An eyeglasses covering that allows a pair of eyeglasses, when not in use, to be worn as a fashion accessory, the eyeglasses covering comprising:
a tubular length of material having a first end and a second end,
wherein the first end has a first opening and the second end has a second opening,
wherein the first opening and the second opening have an elastic material adhered thereto;
a length of flexible wire extending partially through the tubular length of material;
at least two fastening mechanisms for coupling the tubular length of material to the pair of eyeglasses;
at least one stabilizing element applied to an outer surface of the tubular length of material; and
wherein a first temple of the pair of eyeglasses is inserted in the first opening and secured with one of the at least two fastening mechanisms and a second temple of the pair of eyeglasses is inserted in the second opening and secured with the other of the at least two fastening mechanisms.

8. The eyeglasses covering of claim 7 wherein the tubular length of material has patterns, textures, letters, characters, images, symbols, or any combination thereof.

9. The eyeglasses covering of claim 7 wherein the at least two fastening mechanisms are elastic bands, clips, or ties or any combination thereof.

10. The eyeglasses covering of claim 7 wherein the pair of eyeglasses and eyeglasses covering combination is worn around the head or neck when the pair of eyeglasses are not in use.

11. An eyeglasses covering that allows a pair of eyeglasses, when not in use, to be worn as a fashion accessory, the eyeglasses covering comprising:
a unitary length of material having a first end and a second end with an stretchable first opening at the first end and a stretchable second opening at the second end,
wherein the first end is capable of covering at least a first temple, a first lens, and at least a portion of a nose bridge of the pair of eyeglasses when the pair of eyeglasses are not in use,
wherein the second end is capable of covering at least a second temple, a second lens, and at least a portion of the nose bridge of the pair of eyeglasses when the pair of eyeglasses are not in use,
wherein the first end and the second end are capable of being retracted to at least partially expose the first lens and/or second lens when the pair of eyeglasses are in use; and
a length of flexible material extending partially or wholly through the unitary length of material,
wherein the length of flexible material allows the unitary length of material to be shaped and substantially retain that shape.

12. The eyeglasses covering of claim 11 further comprising a lens cleaning material disposed along an inner surface of the eyeglasses covering.

13. The eyeglasses covering of claim 11 wherein the unitary length of material fully covers the nose bridge when the pair of eyeglasses are not in use.

14. The eyeglasses covering of claim 11 wherein the flexible wire is embedded in the length of unitary material.

15. The eyeglasses covering of claim 11 further comprising a stabilizing element coupled to a portion of the unitary length of material.

16. The eyeglasses covering of claim 15 wherein the flexible wire is interwoven with the stabilizing element.

17. The eyeglasses covering of claim 14 wherein there is a pocket along a portion of the unitary length of material configured to retain the flexible wire.
